(19) United States
(12) Patent Application Publication
(10) Pub. No.: US 2026/0124877 A1
(43) Pub. Date: May 7, 2026

(54) THERMAL MANAGEMENT SYSTEM AND THERMAL MANAGEMENT METHOD FOR VEHICLE

(71) Applicants: Hyundai Motor Company, Seoul (KR); Kia Corporation, Seoul (KR)

(72) Inventors: Sun Gyu PARK, Hwaseong-si (KR); Hye Woon JUNG, Hwaseong-si (KR); Han Sang KIM, Hwaseong-si (KR); Kyung Keun SUH, Hwaseong-si (KR); Hyeong Seok LEE, Hwaseong-si (KR)

(73) Assignees: Hyundai Motor Company, Seoul (KR); Kia Corporation, Seoul (KR)

(21) Appl. No.: 19/194,924

(22) Filed: Apr. 30, 2025

(30) Foreign Application Priority Data
Nov. 1, 2024 (KR) 10-2024-0153843

(51) Int. Cl. B60H 1/03; B60H 1/00; F02B 29/04

(52) U.S. Cl. CPC B60H 1/03; B60H 1/00885; F02B 29/0462

(57) ABSTRACT

In a thermal management system and a thermal management method for a vehicle, in which a flow of a coolant in an engine is stopped during internal heating to improve driving efficiency of the engine, the coolant heated by a water-cooled intercooler is delivered to a heater core during an operation of the engine to ensure initial heating heat, and the coolant having passed through the engine or the coolant having passed through the water-cooled intercooler is delivered to the heater core based on a temperature of the coolant so that heating performance is maintained in a state in which driving efficiency of the engine is ensured.

### CROSS-REFERENCE TO RELATED APPLICATION

The present application claims priority to Korean Patent Application No. 10-2024-0153843, filed on Nov. 1, 2024, the entire contents of which is incorporated herein for all purposes by this reference.

### BACKGROUND OF THE PRESENT DISCLOSURE

### Field of the Present Disclosure

The present disclosure relates to a thermal management system and a thermal management method for a vehicle that are configured for ensuring engine efficiency and heating performance in a hybrid vehicle.

### Description of Related Art

Fuel economy of a hybrid vehicle is an important factor. To improve the fuel economy, it is important to increase the amount of traveling time made by a battery to be the amount of traveling time greater than the amount of traveling time made by an engine.

The hybrid vehicle is driven by the engine and the electric motor and utilizes engine waste heat as a heating heat source thereof to heat a vehicle interior. That is, when the vehicle is driven by the engine, engine waste heat is sufficient so that an air conditioning device may be used to heat the vehicle interior in the same way as that of a vehicle in the related art. However, under a condition in which the vehicle is driven by the electric motor, waste heat remaining in an engine coolant is used as the heating heat source even in a state in which the engine is turned off.

However, under the condition in which the vehicle is driven by the electric motor, waste heat in the engine coolant is insufficient to heat a vehicle interior under a condition with a low outside air temperature. Therefore, when the engine coolant has a low temperature, a positive temperature coefficient heater (PTC heater) is used to ensure the heating heat source. However, there are problems in that the PTC heater has low energy efficiency and excessively consumes electric power, which degrades fuel economy of the hybrid vehicle.

Furthermore, when it is expected that heating performance is not satisfied, the engine operates again to ensure heater performance. However, because the present structure does not have a separate heat retention means for maintaining a temperature of the coolant with a temperature raised by heat from the engine, the engine frequently operates, which degrades the fuel economy.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a thermal management system and a thermal management method for a vehicle that are configured for ensuring efficiency of an engine and heating performance when the engine is initially started, and diversifying means for heating a coolant flowing to a heater core in accordance with a coolant temperature or a heating condition.

Technical problems to be solved by the present disclosure are not limited to the above-mentioned technical problems, and other technical problems, which are not mentioned above, may be clearly understood from the following descriptions by those skilled in the art to which the present disclosure pertains.

To achieve the above-mentioned object, the present disclosure provides a thermal management system for a vehicle, the thermal management system including: a heater core configured to heat an interior of a vehicle by waste heat generated from an engine; a water-cooled intercooler configured to cool an intake air to the engine and dissipate heat by a first radiator; and a connection line configured to selectively connect the heater core and the water-cooled intercooler to allow the heater core and the water-cooled intercooler to exchange heat with each other in accordance with an operating state of the engine, the connection line being configured to allow the heater core to perform internal heating by heat generated by the water-cooled intercooler.

According to the exemplary embodiment of the present disclosure, the operating state of the engine may include at least one of a temperature of a coolant in the engine and whether the engine is initially started.

According to the exemplary embodiment of the present disclosure, the operating state of the engine may identify whether the temperature of the coolant in the engine is lower than a preset temperature, which is derived in advance by an experiment to operate the engine with fuel economy when the engine is designed.

According to the exemplary embodiment of the present disclosure, the thermal management system may further include: an engine heat-exchange line including a first line connecting the engine, the heater core, and a first valve, and a second line branching off from a downstream point of the heater core to an upstream point of the water-cooled intercooler.

According to the exemplary embodiment of the present disclosure, in the engine heat-exchange line, a third line, in which a heat-exchange means including at least one of a transmission heat-exchange portion, a motor heat-exchange portion, and an electrical component heat-exchange portion is provided, may be connected to the first line.

According to the exemplary embodiment of the present disclosure, in the engine heat-exchange line, whether to allow a coolant in the engine to flow, whether to allow the coolant having passed through the engine to flow to the heater core, or whether to allow the coolant to flow to the heat-exchange means may be changed by the first valve.

According to the exemplary embodiment of the present disclosure, the thermal management system may further include: a cooling line configured to connect the water-cooled intercooler and a second radiator so that the water-cooled intercooler and the second radiator exchange heat with each other, in which with a second valve, the connection line and the cooling line allow the water-cooled intercooler and the heater core to exchange heat with each other or allow the water-cooled intercooler and the second radiator to exchange heat with each other.

According to the exemplary embodiment of the present disclosure, the operating state of the engine may identify whether a temperature of a coolant in the engine is lower than a preset temperature derived in advance by an experiment to operate the engine with fuel economy when the engine is designed, and a flow of the coolant in the engine may be stopped when the temperature of the coolant of the engine is lower than the preset temperature.

According to the exemplary embodiment of the present disclosure, the thermal management system may further include: an outside air temperature determination portion configured to determine an outside air temperature, in which a flow of a coolant in the engine is stopped when the outside air temperature determination portion determines that the outside air temperature is lower than a preset low-temperature determination temperature.

According to the exemplary embodiment of the present disclosure, during the internal heating including at least one of performing a defrosting mode, setting an internal temperature to a preset heating temperature, and setting an air conditioning blower to a preset stage, the heater core and the water-cooled intercooler may exchange heat with each other through the connection line in accordance with the operating state of the engine.

According to the exemplary embodiment of the present disclosure, the thermal management system may further include: a coolant temperature determination portion configured to determine a temperature of a coolant flowing to the heater core, in which the heater core and the water-cooled intercooler exchange heat with each other through the connection line in accordance with the operating state of the engine when the coolant temperature determination portion determines that the temperature of the coolant flowing to the heater core is lower than a preset minimum heating temperature.

According to the exemplary embodiment of the present disclosure, the thermal management system may further include: a coolant temperature determination portion configured to determine a temperature of a coolant flowing to the heater core, in which the water-cooled intercooler and the first radiator exchange heat with each other when the coolant temperature determination portion determines that the temperature of the coolant flowing to the heater core reaches a preset minimum heating temperature.

Meanwhile, another exemplary embodiment of the present disclosure provides a thermal management method for a vehicle, the thermal management method including: identifying an operating state of an engine; identifying whether a heater core and a water-cooled intercooler are required to exchange heat with each other in accordance with the operating state of the engine; and allowing a heater core to perform internal heating by heat generated from a water-cooled intercooler when the operating state of the engine requires the heat-exchange between heater core and the water-cooled intercooler.

According to the exemplary embodiment of the present disclosure, the identifying of the operating state of the engine may include at least one of a temperature of a coolant in the engine or whether the engine is initially started.

According to the exemplary embodiment of the present disclosure, the identifying of the operating state of the engine may include identifying whether the temperature of the coolant in the engine is lower than a preset temperature derived in advance by an experiment to operate the engine with fuel economy when the engine is designed.

According to the exemplary embodiment of the present disclosure, the thermal management method may further include: stopping a flow of the coolant in the engine when the temperature of the coolant in the engine is lower than the preset temperature in the identifying of the operating state of the engine.

According to the exemplary embodiment of the present disclosure, the thermal management method may further include: determining an outside air temperature; and stopping a flow of a coolant in the engine when the outside air temperature is lower than a preset low-temperature determination temperature in the determining of the outside air temperature.

According to the exemplary embodiment of the present disclosure, the identifying of whether the heater core and the water-cooled intercooler are required to exchange heat with each other may include whether the internal heating including at least one of performing a defrosting mode, setting an internal temperature to a preset heating temperature, and setting an air conditioning blower to a preset stage is performed.

According to the exemplary embodiment of the present disclosure, the thermal management method may further include: determining a temperature of a coolant flowing to the heater core, in which the allowing of the heater core to perform the internal heating includes maintaining the internal heating of the heater core by heat generated from the water-cooled intercooler when the temperature of the coolant flowing to the heater core is lower than a preset minimum heating temperature in the determining of the temperature of the coolant flowing to the heater core.

According to the thermal management system and the thermal management method for a vehicle of the present disclosure, the flow of the coolant in the engine is stopped during the internal heating so that the driving efficiency of the engine is improved. When the engine operates, the coolant heated by the water-cooled intercooler is delivered to the heater core, which ensures initial heating heat.

Furthermore, the coolant having passed through the engine or the coolant having passed through the water-cooled intercooler is delivered to the heater core based on the temperature of the coolant so that the heating performance may be maintained in the state in which the driving efficiency of the engine is ensured.

The effects obtained by the present disclosure are not limited to the aforementioned effects, and other effects, which are not mentioned above, will be clearly understood by those skilled in the art from the following description.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a configuration view of a thermal management system for a vehicle according to an exemplary embodiment of the present disclosure.

FIG. 2 is a configuration view of a control portion of the thermal management system for a vehicle according to an exemplary embodiment of the present disclosure.

FIG. 3 is a circuit diagram of the thermal management system for a vehicle according to an exemplary embodiment of the present disclosure.

FIG. 4 is a view exemplarily illustrating internal heating using a water-cooled intercooler in the circuit diagram of the thermal management system for a vehicle illustrated in FIG. 3.

FIG. 5 is a view exemplarily illustrating internal heating using a coolant in an engine in the circuit diagram of the thermal management system for a vehicle illustrated in FIG. 3.

FIG. 6 is a flowchart of a thermal management method for a vehicle according to an exemplary embodiment of the present disclosure.

FIG. 7 is a detailed flowchart of the thermal management system for a vehicle according to the exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

In the description of the embodiments included in the present specification, the specific descriptions of publicly known related technologies will be omitted when it is determined that the specific descriptions may obscure the subject matter of the embodiments included in the present specification. Furthermore, it should be interpreted that the accompanying drawings are provided only to allow those skilled in the art to easily understand the embodiments included in the present specification, and the technical spirit included in the present specification is not limited by the accompanying drawings, and includes all alterations, equivalents, and alternatives that are included in the spirit and the technical scope of the present disclosure. The following disclosure is not intended to limit the present disclosure to the form or field described, and it is contemplated that various alternative aspects and modifications of the present disclosure are possible, whether expressly stated or implied in the present specification. Those skilled in the art to which the present disclosure pertains will recognize that the form and details of the present disclosure may be changed.

The present disclosure refers to certain aspects by reference. However, as will be understood by those skilled in the art to which the present disclosure pertains, various aspects included in the present specification may be modified or otherwise implemented in various other ways without departing from the spirit and scope of the present disclosure. Therefore, the following description should be considered exemplary and is intended to teach those skilled in the art to which the present disclosure pertains how to make and use the various embodiments. It will be understood that the present disclosure forms illustrated and described in the present specification are to be taken as representative embodiments. Equivalent elements, materials, processes, or steps may be substituted for those representatively exemplified and described in the present disclosure. As used in the present disclosure, expressions such as “including,” “comprising,” “incorporating,” “consisting of,” “have,” “is,” and the like should be construed in a non-exclusive manner, i.e., to permit items, constituent elements, or elements not expressly described to be shown. In addition, references to the singular should be interpreted as including references to the plural.

Furthermore, various embodiments included in the present specification are to be taken in an exemplary and illustrative sense and should not be construed as limiting the scope of the present disclosure. All references to joining (e.g., attached, affixed, coupled, connected, and the like) are intended to assist in understanding the present disclosure only and are not intended to limit the position, orientation, or use of the components or the methods included in the present specification. Therefore, when references to joining are present, these should be interpreted broadly.

Furthermore, these references to joining do not assume that two or more elements are directly connected to each other. Additionally, all numerical terms, e.g., “first,” “second,” “third,” “primary,” “secondary,” “major,” or any other generic or numerical term, are to be taken as identifiers only, to assist in understanding the various components, forms, variations, or modifications of the present disclosure, and are not intended to imply any limitation to any component, form, variation, or modification, or any order or preference thereof. These expressions may be used to describe various constituent elements, but the constituent elements are not limited by the corresponding expressions. The corresponding expressions are used only to distinguish one constituent element from another constituent element.

The suffixes “module”, “unit”, “part”, and “portion” used to describe constituent elements in the following description are used together or interchangeably to facilitate the description, but the suffixes themselves do not have distinguishable meanings or functions.

When one constituent element is described as being “coupled” or “connected” to another constituent element, it should be understood that one constituent element can be coupled or directly connected to another constituent element, and an intervening constituent element can also be present between the constituent elements. When one constituent element is described as being “directly coupled to” or “directly connected to” another constituent element, it should be understood that no intervening constituent element is present between the constituent elements.

A controller may include a communication device configured to communicate with another control unit or a sensor to control a corresponding function, a memory configured to store an operating system, a logic instruction, and input/output information, and one or more processors configured to perform determination, computation, decision, or the like required to control the corresponding function.

In any configuration among the configurations included in the present specification, any number of components or various components may be included in an exemplary embodiment of the present disclosure included in the present specification. The components may include any combination of the features included in the present specification and be disposed in any configuration among various configurations included in the present specification. The concepts related to the use and operations of the components of the present disclosure, as well as the structure and arrangement of the components of the present disclosure, may be applied not only to various exemplary embodiments discussed in the present specification but also to any number of embodiments in any combination. The embodiments including various features of various arrangements will be described below with reference to the drawings.

Hereinafter, various embodiments included in the present specification will be described in detail with reference to the accompanying drawings. The same or similar constituent elements are assigned with the same reference numerals regardless of reference numerals, and the repetitive description thereof will be omitted.

The present disclosure may be applied to a vehicle, which is driven by an engine, or a hybrid vehicle driven by an engine and an electric motor.

In a vehicle provided with an engine 10, waste heat, which is generated when the engine 10 operates, is used for internal heating of the vehicle. That is, heat, which is generated by combusting fuel while the engine 10 operates, is transferred to a coolant to heat the coolant, and the heated coolant is delivered to a heater core 20 and heats air provided to the interior through the heater core 20, thereby heating the interior of the vehicle.

Meanwhile, a coolant temperature for an optimal operation is set when the engine 10 is initially designed. However, in the case of the hybrid vehicle, the engine 10 does not operate sometimes because of the intervention of the electric motor. In case that the engine 10 does not operate because of the intervention of the electric motor, no heat is generated by combustion of the fuel, and thus a temperature of the coolant in the engine 10 decreases.

Because a temperature of the coolant in the engine 10 is low during the internal heating, internal heating efficiency deteriorates, and a supply of a high-temperature coolant to the heater core 20 is retarded, which makes it difficult to ensure heating performance.

Therefore, the present disclosure is directed to ensure a heating speed and heating efficiency by delivering the heated coolant to the heater core 20 through a water-cooled intercooler 40.

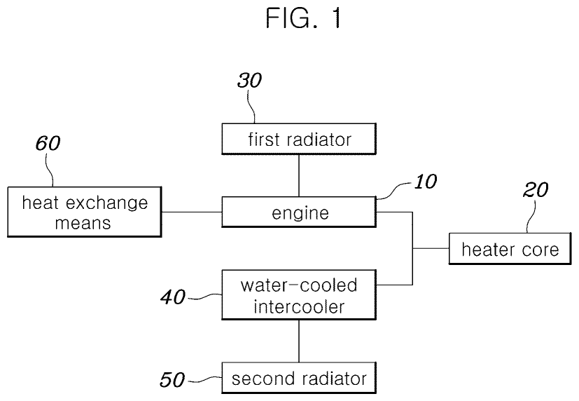

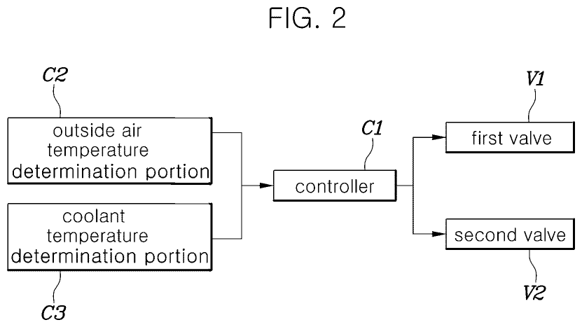

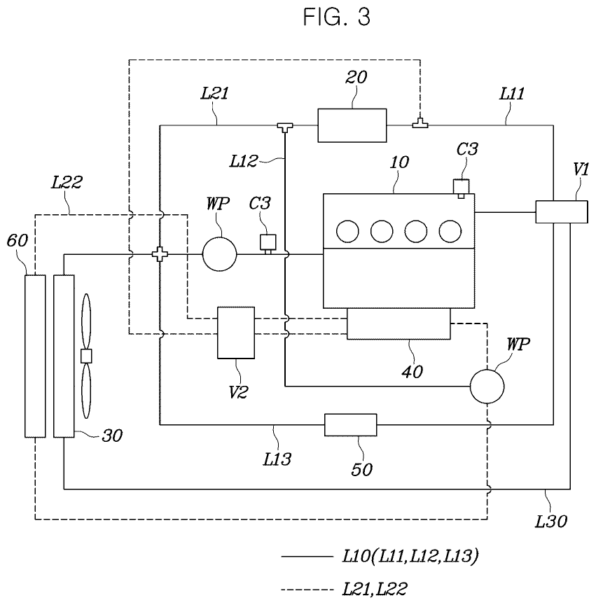

FIG. 1 is a configuration view of a thermal management system for a vehicle according to an exemplary embodiment of the present disclosure, FIG. 2 is a configuration view of a control portion of the thermal management system for a vehicle according to an exemplary embodiment of the present disclosure, and FIG. 3 is a circuit diagram of the thermal management system for a vehicle according to an exemplary embodiment of the present disclosure.

As illustrated in FIG. 1, FIG. 2, and FIG. 3, the present disclosure may include the engine 10, the heater core 20, and the water-cooled intercooler 40. The heater core 20 and the water-cooled intercooler 40 are connected through a connection line L21 and selectively allow the heater core 20 and the water-cooled intercooler 40 to exchange heat with each other in accordance with an operating state of the engine 10.

The heater core 20 is configured so that the coolant having passed through the engine 10 or the water-cooled intercooler 40 circulates therethrough. The high-temperature coolant circulating through the heater core 20 exchanges heat with the air provided into the interior so that heating heat of the air is transferred to the interior.

The water-cooled intercooler 40 is provided to eliminate compression heat generated when a turbocharger compresses air. That is, the water-cooled intercooler 40 utilizes the coolant to eliminate compression heat generated when the turbocharger compresses air. The turbocharger refers to a device that forcibly operates a compressor by use of a flow rate of exhaust gas, which is produced when the engine 10 operates, compresses air, and provides the compressed air to an intake manifold of the engine. The water-cooled intercooler 40 may include a structure for circulating the coolant and allowing the coolant and the compressed air to exchange heat with each other.

In an exemplary embodiment of the present disclosure, the heater core 20 and the water-cooled intercooler 40 are connected through the connection line L21 to perform heat-exchange so that the coolant heated in the water-cooled intercooler 40 may flow to the heater core 20. That is, the water-cooled intercooler 40 utilizes the coolant to eliminate heat generated from the compressed air when the turbocharger operates. In the instant case, because the amount of coolant for cooling the compressed air does not require a high flow rate, the temperature of the coolant is raised relatively rapidly in comparison with the time for which the engine 10 is warmed up.

Therefore, in an exemplary embodiment of the present disclosure, the coolant heated by the water-cooled intercooler 40 flows to the heater core 20 through the connection line L21 without being cooled by a first radiator 30, the heat generated from the water-cooled intercooler 40 may be used to perform the internal heating by the heater core 20. Therefore, it is possible to ensure heating performance by rapidly ensuring the heating heat during the internal heating.

Whether to allow the heater core 20 to perform the internal heating by use of heat generated from the water-cooled intercooler 40 as described above may be determined depending on operating states of the engine 10.

The operating state of the engine may depend on at least one of the temperature of the coolant in the engine 10 or whether the engine 10 is initially started.

In an exemplary embodiment for identifying the operating state of the engine, it is possible to identify whether the temperature of the coolant in the engine 10 is lower than a preset temperature derived in advance by experiments to operate the engine 10 with fuel economy when the engine 10 is designed. For example, the preset temperature may be 90° C. The preset temperature may not be limited to 90° C. and may be set to various temperatures in accordance with the specifications of the engine 10.

That is, the preset temperature of the coolant for optimal operations is determined in advance when the engine 10 is initially designed. In case that the temperature of the coolant in the engine 10 is lower than the preset temperature derived in advance to operate the engine 10 with fuel economy, the coolant having passed through the water-cooled intercooler 40 flows to the heater core 20 through the connection line L21 to perform the internal heating. Therefore, the coolant in the engine 10 may rapidly reach the preset temperature without circulating through the heater core 20. Furthermore, because the coolant more rapidly heated by the water-cooled intercooler 40 than the warming-up of the engine 10, it is possible to ensure the heating performance and heating speed when the coolant heated by the water-cooled intercooler 40 is delivered directly to the heater core 20.

Furthermore, as another exemplary embodiment for identifying the operating state of the engine, whether the engine 10 is initially started may be identified.

That is, because the temperature of the coolant in the engine 10 is low when the engine 10 is initially started, the internal heating cannot be performed by use of the coolant in the engine 10. Therefore, when the engine 10 is initially started, the coolant having passed through the water-cooled intercooler 40 flows to the heater core 20 through the connection line L21 so that the internal heating is performed more rapidly than the warming-up of the engine 10.

Thereafter, when the temperature of the coolant in the engine 10 is higher than the preset temperature or a predetermined time period or more elapses after the engine 10 is initially started, the heating efficiency implemented by performing the internal heating by use of the coolant in the engine 10 is higher than the heating performance implemented by allowing the water-cooled intercooler 40 and the heater core 20 to exchange heat with each other. Therefore, the internal heating may be performed by circulating the coolant in the engine 10 to the heater core 20.

The operation of recognizing the operating state of the engine or changing a flow direction of the coolant may be controlled by a controller C1. The controller C1 may collect various information such as an outside air temperature, a temperature of the coolant, and a vehicle state and control a flow of the coolant or whether to heat the interior by controlling various types of valves or positive temperature coefficient (PTC) heaters.

Meanwhile, as illustrated in FIG. 3, the present disclosure may further include an engine heat-exchange line L10 including a first line L11 connecting the engine 10, the heater core 20, and a first valve V1, and a second line L12 branching off from a downstream point of the heater core 20 to an upstream point of the water-cooled intercooler 40. Water pumps WP for circulating the coolant may be provided in the engine heat-exchange line L10. The water pump WP may be configured as an electric water pump WP. The water pumps WP may be provided as a plurality of water pumps WP.

The engine heat-exchange line L10 includes the first line L11 and the second line L12. The first line L11 defines a route through which the coolant circulates to the engine 10 and the heater core 20. The second line L12 defines a route through which the coolant circulates to the heater core 20 and the water-cooled intercooler 40.

In the instant case, the second line L12 may be connected to the downstream point of the heater core 20 and the upstream point of the water-cooled intercooler 40 in the first line L11, and whether to allow the coolant to flow to the second line L12 may be determined by the first valve V1.

The first valve V1 is a flow rate control valve including an actuator and is configured to control a flow of the coolant including whether to allow the coolant in the engine 10 to flow, whether to allow the coolant to flow to the heater core 20, and whether to circulate the coolant to the second line L12. The first valve V1 including the actuator may be controlled by the controller C1. Furthermore, the first valve V1 is illustrated as being provided at the downstream point of the engine 10. However, the installation position of the first valve V1 is not limited thereto. The first valve V1 may be provided as a plurality of first valves V1 to change a circulation direction of the coolant.

Furthermore, in the engine heat-exchange line L10, a third line L13, in which a heat-exchange means 50 including at least one of a transmission heat-exchange portion, a motor heat-exchange portion, and an electrical component heat-exchange portion is provided, may be connected to the first line L11.

The third line L13 may branch off from the first line L11, and the coolant may be selectively circulated to the heat-exchange means 50 by the first valve V1.

In the instant case, the heat-exchange means 50 includes at least one of the transmission heat-exchange portion, the motor heat-exchange portion, and the electrical component heat-exchange portion. The transmission heat-exchange portion may be an automatic transmission fluid (ATF), the motor heat-exchange portion may be a device for performing thermal management on the motor, and the electrical component heat-exchange portion may be a device for performing thermal management on the electrical component. Furthermore, various components including exhaust gas recirculation (EGR) and configured to manage temperatures while exchanging heat with the circulating coolant may be included.

Therefore, in the engine heat-exchange line L10, the coolant may be selectively circulated to the engine 10, the heater core 20, the water-cooled intercooler 40, and the heat-exchange means 50 by the first valve V1. As an example, the first valve V1 may be a four-way valve for controlling the circulation of the coolant. An element having any other type can be adapted to the present disclosure by the persons skilled in the art, if necessary. The thermal management efficiency of the coolant may be improved by the internal heating made by the heater core 20 and the heat-exchange through the components.

In the engine heat-exchange line L10, whether to allow the coolant in the engine 10 to flow, whether to allow the coolant having passed through the engine 10 to flow to the heater core 20, or whether to allow the coolant to flow to the heat-exchange means 50 may be changed by the first valve V1.

For example, various types of thermal management may be implemented by allowing the coolant, which is heated while passing through the engine 10, to circulate to the heater core 20 to perform the internal heating, cooling other components by the heat-exchange means 50 to circulate the heated coolant to the heater core 20 and perform the internal heating, or circulating the coolant by a heat pump. To the present end, an operation of opening or closing the first valve V1 may be controlled by the controller C1, and the heated coolant circulates to the heater core 20 through various routes, which may improve the internal heating efficiency.

Meanwhile, the present disclosure may further include a cooling line L22 that connects the water-cooled intercooler 40 and a second radiator 60 so that the water-cooled intercooler 40 and the second radiator 60 may exchange heat with each other. With a second valve V2, the connection line L21 and the cooling line L22 may allow the water-cooled intercooler 40 and the heater core 20 to exchange heat with each other or allow the water-cooled intercooler 40 and the second radiator 60 to exchange heat with each other. The water pumps WP for circulating the coolant may be provided in the cooling line L22. The water pump WP may be configured as an electric water pump WP. The water pumps WP may be provided as a plurality of water pumps WP.

The second valve V2 is a flow rate control valve including an actuator. In case that the second valve V2 allows the coolant having passed through the water-cooled intercooler 40 to move to the heater core 20, the coolant heated in the water-cooled intercooler 40 may exchange heat with the air through the heater core 20 to perform the internal heating and lower the temperature of the coolant. In case that the second valve V2 allows the coolant having passed through the water-cooled intercooler 40 to move to the second radiator 60, the temperature of the coolant may be lowered by the second radiator 60.

The second valve V2 including an actuator may be controlled by the controller C1. Furthermore, the second valve V2 may be provided at the downstream point of the water-cooled intercooler 40, and the second valve V2 may circulate the coolant to the connection line L21 or the cooling line L22.

Therefore, the internal heating may be performed by the heater core 20 by use of the coolant having passed through the water-cooled intercooler 40. Alternatively, the coolant is cooled by the heater core 20 or the second radiator 60 and then circulated back to the water-cooled intercooler 40 so that the temperature of the compression heat may be adjusted.

Furthermore, the present disclosure may further include a line L30 that connects the engine 10, the first radiator 30 and the first valve V1.

Meanwhile, based on the operating state of the engine, it is possible to identify that the temperature of the coolant in the engine 10 is lower than the preset temperature derived in advance by experiments to operate the engine 10 with fuel economy when the engine 10 is designed. In case that the temperature of the coolant in the engine 10 is lower than the preset temperature, the flow of the coolant in the engine 10 may be stopped.

The preset temperature of the coolant for optimal operations is determined when the engine 10 is initially designed. In case that the temperature of the coolant in the engine 10 is lower than the preset temperature derived in advance to operate the engine 10 with fuel economy, the flow of the coolant in the engine 10 is stopped so that a speed at which the temperature of the coolant in the engine 10 reaches the preset temperature may be increased, and a degree to which the coolant circulates to components other than the engine 10 and the temperature of the coolant circulating through the engine is changed may be minimized.

The operation of stopping the flow of the coolant in the engine 10 may be controlled by the above-mentioned first valve V1, and an additional valve may be further provided in the route, through which the coolant flows to the engine 10, to change whether to allow the coolant to flow to the engine 10. As described above, the coolant in the engine 10 is maintained in the engine 10 without circulating to the outside so that a speed at which the engine 10 reaches the preset temperature may be increased, and the efficiency of the engine 10 may be ensured. Even though the operation of the engine 10 is repeatedly turned on or off, the temperature of the coolant in the engine 10 may be maintained so that the driving efficiency of the engine 10 may be ensured.

Meanwhile, the present disclosure may further include an outside air temperature determination portion C2 configured to determine an outside air temperature. The outside air temperature determination portion C2 may be an outside air temperature sensor or be configured to receive an outside air temperature through external communication.

The outside air temperature determination portion C2 is configured to determine that the outside air temperature is lower than a preset low-temperature determination temperature, the flow of the coolant in the engine 10 may be stopped. In the instant case, for example, the low-temperature determination temperature may be 10° C. The low-temperature determination temperature may be a temperature which may affect the temperature of the coolant during the internal heating. However, the low-temperature determination temperature may be set to various temperatures without being limited to the above-mentioned temperature.

In an exemplary embodiment of the present disclosure, when the outside air temperature is lower than the preset low-temperature determination temperature, the flow of the coolant in the engine 10 is stopped so that the speed at which the temperature of the coolant in the engine 10 reaches the preset temperature may be increased. Furthermore, a warming-up speed of the engine 10 may be increased, which may ensure the driving efficiency of the engine 10.

Meanwhile, during the internal heating including at least one of performing a defrosting mode, setting an internal temperature to a preset heating temperature, or setting an air conditioning blower to a preset stage, the heater core 20 and the water-cooled intercooler 40 may exchange heat with each other through the connection line L21 in accordance with the operating state of the engine 10.

In an exemplary embodiment of the present disclosure, in a situation in which the heating performance made by the heater core 20 deteriorates, such as an initial situation of the engine 10 or a situation in which the temperature of the coolant in the engine 10 is low, the heater core 20 and the water-cooled intercooler 40 exchange heat with each other through the connection line L21.

In case that a necessary heating temperature is low during the internal heating, the temperature of the coolant circulating to the heater core 20 is also relatively low so that the internal heating may be performed only by the PTC heater, or the internal heating may be performed only by a temperature of the coolant heated by operation of the engine 10.

However, in the case of the performing of the defrosting mode, the setting of the internal temperature to the preset heating temperature, or the setting of the air conditioning blower to the preset stage, an internal heating temperature needs to be rapidly raised, or a high heating temperature is required so that the coolant heated in the water-cooled intercooler 40 circulates to the heater core 20 through the connection line L21, and the heating heat is rapidly provided through the heater core 20. In the instant case, the defrosting mode is a mode performed when frost occurs because an internal humidity is high or a temperature is low. For example, the preset heating temperature may be 30° C. or more, i.e., a temperature that requires a high internal temperature. For example, the preset stage of the air conditioning blower may be a maximum operating stage of the blower.

As described above, the heating heat is selectively provided to the heater core 20 by use of the water-cooled intercooler 40 in accordance with the heating condition, which may ensure efficient heating performance.

Meanwhile, a coolant temperature determination portion C3 electrically connected to the controller C1 and configured to determine a temperature of the coolant flowing to the heater core 20 may be further included. The coolant temperature determination portion C3 is a coolant temperature sensor and may be provided in the line through which the coolant circulates. The coolant temperature determination portion C3 may be provided as a plurality of coolant temperature determination portions C3 and configured for measuring temperatures such as a temperature of the coolant to be introduced into the engine, a temperature of the coolant having passed through the engine, and a temperature of the coolant flowing to the heater core.

In case that the coolant temperature determination portion C3 determines that the temperature of the coolant flowing to the heater core 20 is lower than the preset minimum heating temperature, the heater core 20 and the water-cooled intercooler 40 may exchange heat with each other through the connection line L21 in accordance with the operating state of the engine. The present operation may be performed by controlling the first valve V1 and/or the second valve V2 by the controller C1.

In the instant case, for example, the minimum heating temperature may be 30° C. The minimum heating temperature is not limited to the corresponding temperature and is set to a temperature required for the internal heating by the heater core 20.

As described above, the temperature of the coolant flowing to the heater core 20 is identified. In case that the temperature of the coolant is lower than the minimum heating temperature, the coolant heated by the water-cooled intercooler 40 may flow to the heater core 20 so that the coolant may rapidly reach the heating condition by the heater core 20.

That is, because the amount of coolant for eliminating heat generated from the compressed air is small in the water-cooled intercooler 40, a speed at which the coolant is heated by the compression heat is high. Therefore, in case that the coolant heated by the water-cooled intercooler 40 circulates to the heater core 20, the achievement of the heating performance by the heater core 20 may be accelerated.

Thereafter, in case that the coolant temperature determination portion C3 determines that the temperature of the coolant flowing to the heater core 20 reaches the preset minimum heating temperature, the water-cooled intercooler 40 and the first radiator 30 may exchange heat with each other.

That is, the situation in which the temperature of the coolant flowing to the heater core 20 reaches the minimum heating temperature is a state in which the heating performance of the heater core 20 is ensured, and the situation may be a time point at which the warming-up of the engine 10 is completed. When the heating performance of the heater core 20 is ensured, the coolant having passed through the water-cooled intercooler 40 is circulated to the first radiator 30 and cooled, which may ensure the performance in cooling the compressed air by the water-cooled intercooler 40.

As described above, in an exemplary embodiment of the present disclosure, the heating performance by the heater core 20 is ensured by circulating the coolant, which is heated by the water-cooled intercooler 40, to the heater core 20 under a preferential heating condition in accordance with the operating state of the engine including the initial starting of the engine 10, the warming-up situation of the engine 10, or the like.

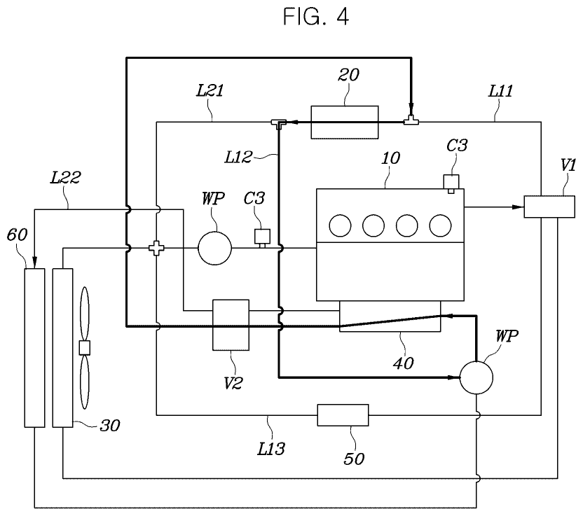

That is, as illustrated in FIG. 4, the coolant, which is heated by the water-cooled intercooler 40, is circulated to the heater core 20 by the first valve V1 and the second valve V2 so that the heater core 20 performs the internal heating, and the flow of the coolant in the engine 10 is stopped so that the increase in temperature of the coolant in the engine 10 may be accelerated.

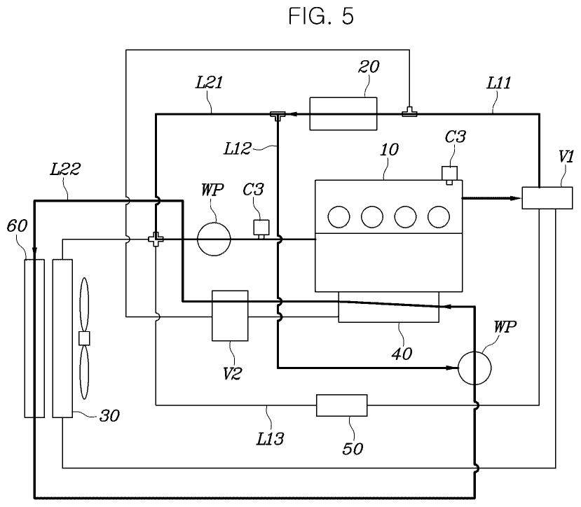

Meanwhile, when the temperature of the coolant in the engine 10 reaches the temperature condition set based on a temperature for ensuring the driving efficiency of the engine 10 and performing the internal heating, the coolant, which is heated by the engine 10, may be circulated to the heater core 20 by the first valve V1 and the second valve V2, and the coolant, which is heated by the water-cooled intercooler 40, may be cooled by the second radiator 60, as illustrated in FIG. 5.

As described above, in an exemplary embodiment of the present disclosure, the flow of the coolant in the engine 10 is stopped during the internal heating so that the driving efficiency of the engine 10 is improved. When the engine 10 operates, the coolant heated by the water-cooled intercooler 40 is delivered to the heater core 20, which ensures initial heating heat.

Furthermore, the coolant having passed through the engine 10 or the coolant having passed through the water-cooled intercooler 40 is delivered to the heater core 20 based on the temperature of the coolant so that the heating performance may be maintained in the state in which the driving efficiency of the engine 10 is ensured.

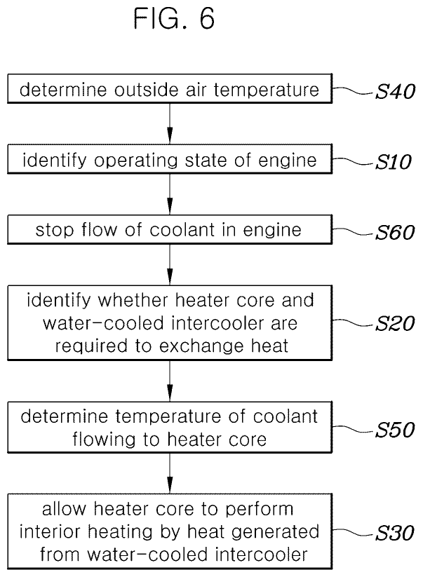

Meanwhile, as illustrated in FIG. 6, a thermal management method for a vehicle according to an exemplary embodiment of the present disclosure may include identifying the operating state of the engine (S10), identifying whether the heater core 20 and the water-cooled intercooler 40 are required to exchange heat with each other in accordance with the operating state of the engine (S20), and allowing the heater core 20 to perform the internal heating by heat generated by the water-cooled intercooler 40 when the operating state of the engine requires the heat-exchange between the heater core 20 and the water-cooled intercooler 40 (S30).

In the instant case, the identifying of the operating state of the engine (S10) may include at least one of the temperature of the coolant in the engine 10 or whether the engine 10 is initially started.

In the identifying of the operating state of the engine (S10), it is possible to identify whether the temperature of the coolant in the engine 10 is lower than the preset temperature derived in advance by experiments to operate the engine 10 with fuel economy when the engine 10 is designed.

In an exemplary embodiment for identifying the operating state of the engine, it is possible to identify whether the temperature of the coolant in the engine 10 is lower than the preset temperature derived in advance by experiments to operate the engine 10 with fuel economy when the engine 10 is designed. For example, the preset temperature may be 90° C. The preset temperature may not be limited to 90° C. and may be set to various temperatures in accordance with the specifications of the engine 10.

Furthermore, as another exemplary embodiment for identifying the operating state of the engine, whether the engine 10 is initially started may be identified.

That is, because the temperature of the coolant in the engine 10 is low when the engine 10 is initially started, the internal heating cannot be performed by use of the coolant in the engine 10.

As described above, in accordance with the temperature of the coolant in the engine 10 or whether the engine 10 is initially started, the coolant having passed through the water-cooled intercooler 40 flows to the heater core 20 through the connection line L21 and performs the internal heating so that the internal heating may be performed more rapidly than the warming-up of the engine 10.

Meanwhile, the identifying of the operating state of the engine (S10) may include stopping the flow of the coolant in the engine 10 when the temperature of the coolant in the engine 10 is lower than the preset temperature (S60).

As described above, the preset temperature of the coolant for optimal operations is determined when the engine 10 is initially designed. In case that the temperature of the coolant in the engine 10 is lower than the preset temperature derived in advance to operate the engine 10 with fuel economy, the flow of the coolant in the engine 10 is stopped so that a speed at which the temperature of the coolant in the engine 10 reaches the preset temperature may be increased, and a degree to which the coolant circulates to components other than the engine 10 and the temperature of the coolant is changed may be minimized.

Furthermore, the thermal management method for a vehicle may further include determining an outside air temperature (S40). In the determining of the outside air temperature (S40), the stopping of the flow of the coolant in the engine 10 (S60) may be performed in case that the outside air temperature is lower than the preset low-temperature determination temperature.

When the outside air temperature is lower than the preset low-temperature determination temperature, the flow of the coolant in the engine 10 is stopped so that the speed at which the temperature of the coolant in the engine 10 reaches the preset temperature may be increased. Furthermore, a warming-up speed of the engine 10 may be increased, which may ensure the driving efficiency of the engine 10.

Meanwhile, the identifying of whether the heater core 20 and the water-cooled intercooler 40 are required to exchange heat with each other (S20) may include whether the internal heating including at least one of performing the defrosting mode, setting the internal temperature to the preset heating temperature, and setting the air conditioning blower to the preset stage is performed.

In the instant case, the defrosting mode is a mode performed when frost occurs because an internal humidity is high or a temperature is low. For example, the preset heating temperature may be 30° C. or more, i.e., a temperature that requires a high internal temperature. For example, the operation of the air conditioning blower may be a maximum amount of operation of the blower.

As described above, the heating heat is selectively provided to the heater core 20 by use of the water-cooled intercooler 40 in accordance with the heating condition, which may ensure efficient heating performance.

Meanwhile, the thermal management method for a vehicle may further include determining the temperature of the coolant flowing to the heater core 20 (S50). The allowing of the heater core to perform the internal heating (S30) may include maintaining the internal heating of the heater core 20 by heat generated from the water-cooled intercooler 40 in case that the temperature of the coolant flowing to the heater core 20 is lower than the preset minimum heating temperature in the determining of the temperature of the coolant flowing to the heater core 20 (S50).

As described above, the temperature of the coolant flowing to the heater core 20 is identified. In case that the temperature of the coolant is lower than the minimum heating temperature, the coolant heated by the water-cooled intercooler 40 may flow to the heater core 20 so that the coolant may rapidly reach the heating condition by the heater core 20.

That is, because the amount of coolant for eliminating heat generated from the compressed air is small in the water-cooled intercooler 40, a speed at which the coolant is heated by the compression heat is high. Therefore, in case that the coolant heated by the water-cooled intercooler 40 circulates to the heater core 20, the heating performance by the heater core 20 may be rapidly ensured.

Thereafter, in case that the coolant temperature determination portion C3 determines that the temperature of the coolant flowing to the heater core 20 reaches the preset minimum heating temperature, the water-cooled intercooler 40 and the first radiator 30 may exchange heat with each other.

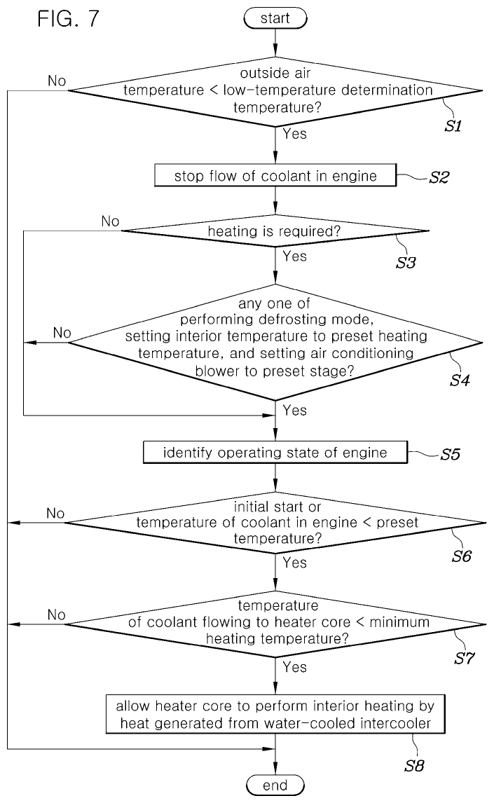

The above-mentioned thermal management method according to an exemplary embodiment of the present disclosure vehicle may be controlled in accordance with the detailed flowchart according to steps S1 to S8 illustrated in FIG. 7. The control according to the outside air temperature, the control according to the heating requirement, and the control related to the identification of the operating state of the engine may be changed in order in accordance with the design condition or situation without being limited to the corresponding flowchart.

As described above, according to the thermal management system and the thermal management method for a vehicle of the present disclosure, the flow of the coolant in the engine 10 is stopped during the internal heating so that the driving efficiency of the engine 10 is improved. When the engine 10 operates, the coolant heated by the water-cooled intercooler 40 is delivered to the heater core 20, which ensures initial heating heat.

Furthermore, the coolant having passed through the engine 10 or the coolant having passed through the water-cooled intercooler 40 is delivered to the heater core 20 based on the temperature of the coolant so that the heating performance may be maintained in the state in which the driving efficiency of the engine 10 is ensured.

Furthermore, the term related to a control device such as “controller”, “control apparatus”, “control unit”, “control device”, “control module”, “control circuit”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured for processing data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), Silicon Disk Drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like. Furthermore, the non-transitory computer-readable recording medium may be distributed over computer systems connected through a network, and computer-readable program code may be stored and executed in a distributive manner.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Software implementations may include software components (or elements), object-oriented software components, class components, task components, processes, functions, attributes, procedures, subroutines, program code segments, drivers, firmware, microcode, data, database, data structures, tables, arrays, and variables. The software, data, and the like may be stored in memory and executed by a processor. The memory or processor may employ a variety of means well known to a person having ordinary knowledge in the art.

Furthermore, the terms such as “unit”, “module”, etc. included in the specification mean units for processing at least one function or operation, which may be implemented by hardware, software, or a combination thereof.

In the flowchart described with reference to the drawings, the flowchart may be performed by the controller or the processor. The order of operations in the flowchart may be changed, multiple operations may be merged, or any operation may be divided, and a specific operation may not be performed. Furthermore, the operations in the flowchart may be performed sequentially, but not necessarily performed sequentially. For example, the order of the operations may be changed, and at least two operations may be performed in parallel.

Hereinafter, the fact that pieces of hardware are coupled operatively may include the fact that a direct and/or indirect connection between the pieces of hardware is established by wired and/or wirelessly.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “or” used in an exemplary embodiment of the present disclosure should be interpreted as indicating “additionally or alternatively.”

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

The terms used to describe the embodiments are used for describing specific embodiments, and are not intended to limit the embodiments. As used in the description of the embodiments and in the claims, the singular forms “a”, “an”, and “the” include plural referents unless the context clearly dictates otherwise. The expression “and/or” is used to include all possible combinations of terms.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

As used herein, conditional expressions such as “if” and “when” are not limited to an optional case and are intended to be interpreted, when a specific condition is satisfied, to perform the related operation or interpret the related definition according to the specific condition.

Terms such as first and second may be used to describe various elements of the embodiments. However, various components according to the exemplary embodiments should not be limited by the above terms. These terms are only used to distinguish one element from another.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A thermal management system for a vehicle, the thermal management system comprising:
a heater core configured to heat an interior of the vehicle by waste heat generated from an engine;
a water-cooled intercooler configured to cool an intake air to the engine and dissipate heat by a first radiator; and
a connection line configured to selectively connect the heater core and the water-cooled intercooler to allow the heater core and the water-cooled intercooler to exchange heat with each other in accordance with an operating state of the engine, the connection line being configured to allow the heater core to perform internal heating of the interior of the vehicle by heat generated by the water-cooled intercooler.

2. The thermal management system of claim 1, wherein the operating state of the engine includes at least one of a temperature of a coolant in the engine and whether the engine is initially started.

3. The thermal management system of claim 2, further including a controller,
wherein based on the operating state of the engine, the controller is configured to identify whether the temperature of the coolant in the engine is lower than a preset temperature, which is derived in advance by an experiment to operate the engine with fuel economy based on that the engine is designed.

4. The thermal management system of claim 1, further including:
an engine heat-exchange line including a first line connecting the engine, the heater core, and a first valve, and a second line branching off from a downstream point of the heater core to an upstream point of the water-cooled intercooler.

5. The thermal management system of claim 4,
wherein the engine heat-exchange line further includes a third line connected to the first line, and
wherein a heat-exchange means including at least one of a transmission heat-exchange portion, a motor heat-exchange portion, and an electrical component heat-exchange portion is provided in the third line.

6. The thermal management system of claim 5, further including a controller,
wherein in the engine heat-exchange line, whether to allow a coolant in the engine to flow, whether to allow the coolant having passed through the engine to flow to the heater core, or whether to allow the coolant to flow to the heat-exchange means is changed by the first valve electrically connected to the controller.

7. The thermal management system of claim 1, further including:
a controller;
a cooling line configured to connect the water-cooled intercooler and a second radiator so that the water-cooled intercooler and the second radiator exchange heat with each other; and
a second valve electrically connected to the controller, wherein by the second valve, the connection line and the cooling line allow the water-cooled intercooler and the heater core to exchange heat with each other or allow the water-cooled intercooler and the second radiator to exchange heat with each other.

8. The thermal management system of claim 1, further including a controller,
wherein based on the operating state of the engine, the controller is configured to identify whether a temperature of a coolant in the engine is lower than a preset temperature derived in advance by an experiment to operate the engine with fuel economy based on that the engine is designed, and
wherein a flow of the coolant in the engine is stopped by the controller based on that the temperature of the coolant of the engine is lower than the preset temperature.

9. The thermal management system of claim 1, further including:
a controller; and
an outside air temperature determination portion electrically connected to the controller and configured to determine an outside air temperature,
wherein a flow of a coolant in the engine is stopped by the controller based on that the controller concludes that the outside air temperature is lower than a preset low-temperature determination temperature.

10. The thermal management system of claim 1, wherein during the internal heating including at least one of performing a defrosting mode, setting an internal temperature to a preset heating temperature, and setting an air conditioning blower to a preset stage, the heater core and the water-cooled intercooler exchange heat with each other through the connection line in accordance with the operating state of the engine.

11. The thermal management system of claim 1, further including:
a controller; and
a coolant temperature determination portion electrically connected to the controller and configured to determine a temperature of a coolant flowing to the heater core,
wherein the heater core and the water-cooled intercooler exchange heat with each other through the connection line in accordance with the operating state of the engine based on that the controller conclude that the temperature of the coolant flowing to the heater core is lower than a preset minimum heating temperature.

12. The thermal management system of claim 1, further including:
a controller;
a coolant temperature determination portion electrically connected to the controller and configured to determine a temperature of a coolant flowing to the heater core,
wherein the water-cooled intercooler and the first radiator exchange heat with each other based on that the controller concludes that the temperature of the coolant flowing to the heater core reaches a preset minimum heating temperature.

13. A thermal management method for a vehicle, the thermal management method comprising:
identifying, by a controller, an operating state of an engine;
identifying, by the controller, whether a heater core and a water-cooled intercooler are required to exchange heat with each other in accordance with the operating state of the engine; and
allowing, by the controller, the heater core to perform internal heating by heat generated from the water-cooled intercooler based on that the controller concludes that the operating state of the engine requires the heat-exchange between the heater core and the water-cooled intercooler.

14. The thermal management method of claim 13, wherein the identifying of the operating state of the engine further includes identifying at least one of a temperature of a coolant in the engine or whether the engine is initially started.

15. The thermal management method of claim 14, wherein the identifying of the operating state of the engine includes identifying whether the temperature of the coolant in the engine is lower than a preset temperature derived in advance by an experiment to operate the engine with fuel economy based on that the engine is designed.

16. The thermal management method of claim 15, further including:
stopping, by the controller, a flow of the coolant in the engine based on that the temperature of the coolant in the engine is lower than the preset temperature in the identifying of the operating state of the engine.

17. The thermal management method of claim 13, further including:
determining, by the controller, an outside air temperature; and
stopping, by the controller, a flow of a coolant in the engine based on that the outside air temperature is lower than a preset low-temperature determination temperature in the determining of the outside air temperature.

18. The thermal management method of claim 13, wherein the identifying of whether the heater core and the water-cooled intercooler are required to exchange heat with each other includes identifying whether the internal heating including at least one of performing a defrosting mode, setting an internal temperature to a preset heating temperature, and setting an air conditioning blower to a preset stage.

19. The thermal management method of claim 13, further including:
determining, by the controller, a temperature of a coolant flowing to the heater core,
wherein the allowing of the heater core to perform the internal heating includes maintaining the internal heating of the heater core by heat generated from the water-cooled intercooler based on that the controller concludes that the temperature of the coolant flowing to the heater core is lower than a preset minimum heating temperature in the determining of the temperature of the coolant flowing to the heater core.
